(19) United States
(12) Patent Application Publication
(10) Pub. No.: US 2026/0054409 A1
(43) Pub. Date: Feb. 26, 2026

(54) FLIP PLATFORM FOR A COMBINATION SAW MOTOR WITH CIRCULAR BLADE

(71) Applicant: Mitch David Heuer, Mancos, CO (US)

(72) Inventor: Mitch David Heuer, Mancos, CO (US)

(21) Appl. No.: 18/814,503

(22) Filed: Aug. 24, 2024

(51) Int. Cl. B27B 5/16

(52) U.S. Cl. CPC B27B 5/165

(57) ABSTRACT

A unique flip platform is configured to be used in conjunction with a combination saw motor with a circular blade that enables it to be used in a dual-purpose manner for both cross cuts and rip-cuts. The combination saw motor with a circular blade is rotated 90° horizontally on the flip platform, and a middle portion of the top surface of the flip platform supported between the legs of the table is flipped over 180° vertically so the combination saw motor with a circular blade is now on the bottom of the platform. The blade of the combination saw motor with a circular blade extends upward through a slot in the middle portion of the platform surface to allow the user to make rip-cuts along the length of a workpiece. Heretofore two distinctly different saws were required, one to make cross cuts and one to make rip-cuts.

### BACKGROUND

Various saws are used on construction sites and in wood shops. Some saws are hand-held. Other saws are securely attached to a table/platform (hereinafter referred to as a “platform”) to enable the user to stand erect while using the saw and to provide a flat surface to rest the workpieces of wood that need to be cut.

### SUMMARY

This Summary is provided to introduce in a simplified form a selection of concepts that are further described below in the Detailed Description. This Summary is not intended to identify key or essential features of the claimed subject matter, nor is it intended to be used to limit the scope of the claimed subject matter.

A commonly called “cross cut saw” or a “compound sliding miter saw” is typically used to cut angle cuts across the grain in woodworking and construction projects and is often mounted or placed upon a platform. A commonly called “table saw” is typically used to rip-cut wood along the grain for longer lengths of wood and the saw motor and its circular blade are mounted on the bottom side of a platform with the circular blade extending above the surface of the platform through a slot. A unique flip platform for a new combination saw motor with a circular blade is disclosed. This combination saw motor with a circular blade described herein will refer to both the common types of saws described above—first, the commonly called “cross cut saw” or a “compound sliding miter saw,” and second, the commonly called “table saw.” The unique flip platform is configured to be used in conjunction with the combination saw motor with a circular blade that enables the combination saw motor with a circular blade to be used in a dual-purpose manner for both cross cuts and rip-cuts without having to move the entire table to have access and proper orientation up next to a wall and to avoid obstructions while in the “rip” configuration. The combination saw motor with a circular blade is securely attached in a first position to the top surface of the flip platform and in this first position is used to make typical cross cuts on workpieces. In a second position, the combination saw motor with a circular blade with its base is rotated 90 degrees clockwise horizontally on the flip platform top. Next, a middle portion of the top surface of the flip platform supported between the legs of the flip platform is flipped over 180 degrees vertically so the combination saw motor with a circular blade is now on the bottom of the flip platform. The blade of the combination saw motor with a circular blade and its riving knife extends upward through a slot in a middle portion of the flip platform surface to allow the user to make rip-cuts along the length of a workpiece. These rotations allow for the workpieces being cut to remain in the same basic orientation when the workpieces are on top of the flip platform, left to right, in both cutting modes of the combination saw motor with a circular blade, cross cuts and rip-cuts. Heretofore two distinctly different saw devices were required, one for cross cuts with the saw mounted on the top of a platform, and one for rip-cuts with the saw mounted on the bottom of a platform. Often two distinctly different saws were needed to make these two distinctly different types of cuts. The unique flip platform that rotates 90 degrees horizontally and flips 180 degrees vertically provides a great advantage in eliminating the need for two saw platforms and two saw devices. One combination saw motor with a circular blade paired with the unique flip platform can now accomplish both types of cuts with little effort in transitioning between a first position of the flip platform for making cross cuts and a second position of the flip platform for making rip-cuts.

### BRIEF DESCRIPTION OF THE VIEWS OF THE DRAWINGS

FIG. 1 shows a perspective view of an embodiment of a flip platform for a combination saw motor with a circular blade in a “cross cut” configuration.

FIG. 2 shows a perspective view of an embodiment of a flip platform for a combination saw motor with a circular blade beginning a 90 degree clockwise horizontal rotation.

FIG. 3 shows a perspective view of an embodiment of a flip platform for a combination saw motor with a circular blade fully rotated 90 degrees clockwise horizontally.

FIG. 4 shows a perspective view of an embodiment of a flip platform for a combination saw motor with a circular blade beginning a 180 degree vertical rotation.

FIG. 5 shows a perspective view of an embodiment of a flip platform for a combination saw motor with a circular blade fully rotated 180 degrees vertically.

FIG. 6 shows a method for converting a flip platform from a cross cut orientation to a rip-cut orientation for use with a combination saw motor with a circular blade in an embodiment of the invention of a flip platform for a combination saw motor with a circular blade.

Table of Components

| COMPONENT | # |
|---|---|
| combination saw motor | 1 |
| left flip platform rotation point | 2 |
| right flip platform rotation point | 3 |
| lateral support member | 4 |
| base | 5 |
| rotatable platform base | 6 |
| latch | 7 |
| center rotation point | 8 |
| table saw fence | 9 |
| flip platform slot | 10 |
| saw blade | 11 |
| flip platform | 12 |
| leg | 13 |
| base slot | 14 |
| riving knife | 15 |

### DETAILED DESCRIPTION

Referring now to the Figures, like reference numerals and names refer to structurally and/or functionally similar elements thereof, and if objects depicted in the figures that are covered by another object, as well as the tag line for the element number thereto, may be shown in dashed lines.

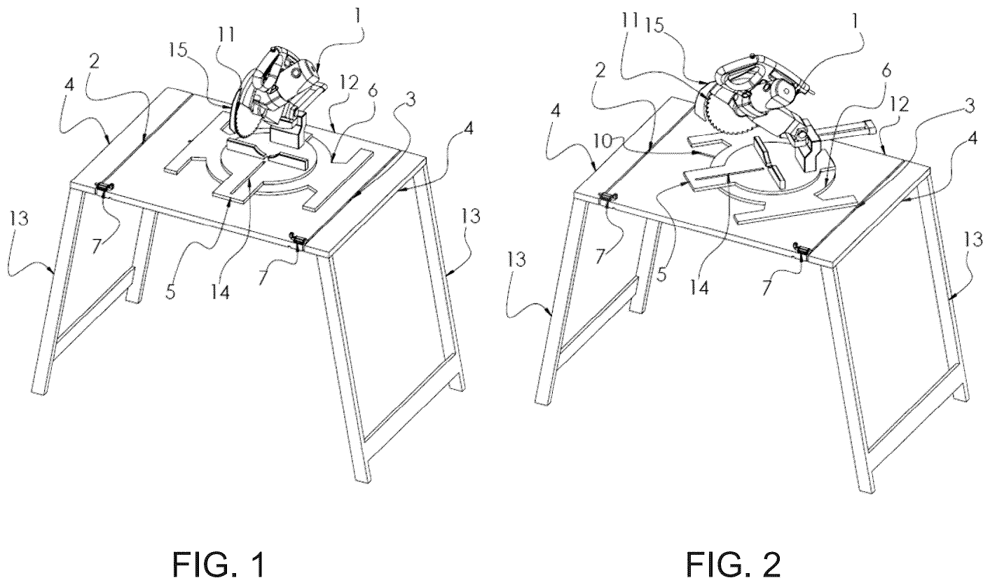

FIG. 1 shows a perspective view of an embodiment of a flip platform for a combination saw motor with a circular blade in a “cross cut” configuration. Referring now to FIG. 1, combination saw motor 1 comes with a saw blade 11 and with a base 5 that is secured to rotatable platform base 6 with screws or any other conventional attachment means known in the art. Rotatable platform base 6 is secured to flip platform 12 around a center rotation point 8 (see FIG. 5) such that rotatable platform base 6 can freely rotate on flip platform 12 around center rotation point 8. This may be accomplished with a central bearing located at center rotation point 8 or a lazy Susan turntable ring centered around center rotation point 8.

Flip platform 12 is secured between a left horizontal lateral support member 4 and a right horizontal lateral support member 4 at a left flip platform rotation point 2 located at a midpoint along the left horizontal lateral support member 4 and at a midpoint along a left side of flip platform 12, and at a right flip platform rotation point 3 located at a midpoint along the right horizontal lateral support member 4 and at a midpoint along a right side of flip platform 12. Flip platform 12 is rotatable vertically about left flip platform rotation point 2 and right flip platform rotation point 3 via a left metal pivot pin and a right metal pivot pin within metal sockets (not visible) that are internal to the left horizontal lateral support member 4 and a right horizontal lateral support member 4 and the left side of flip platform 12 and the right side of flip platform 12. Two latches 7 on opposite sides of flip platform 12 secure flip platform 12 in the first horizontal position configured for cross cuts and in the 180 degree flipped second horizontal position for rip-cuts. In one embodiment, latches 7 are a spring-loaded sliding bolt action bolt with a receiving socket/hole and a pull handle. One skilled in the art will recognize that many other types of latches 7 may be utilized. Each horizontal lateral support member 4 is supported by two legs 13 which elevates flip platform 12 to a convenient working height for cutting workpieces while standing. Legs 13 may be adjustable to increase or lower the height of flip platform 12 for the convenience of an individual user. Saw blade 11 and riving knife 15 extend through base slot 14 to extend the cut below the bottom of the workpiece.

FIG. 2 shows a perspective view of an embodiment of a flip platform for a combination saw motor with a circular blade beginning a 90 degree clockwise horizontal rotation. Referring now to FIG. 2, to begin the conversion from making cross cuts to making rip-cuts, rotatable platform base 6 is unlocked from its current position and begun to rotate clockwise. In one embodiment, rotatable platform base 6 locks are a spring-loaded sliding bolt action bolt with a receiving socket/hole and a pull handle. One skilled in the art will recognize that many other types of rotatable platform base 6 locks may be utilized.

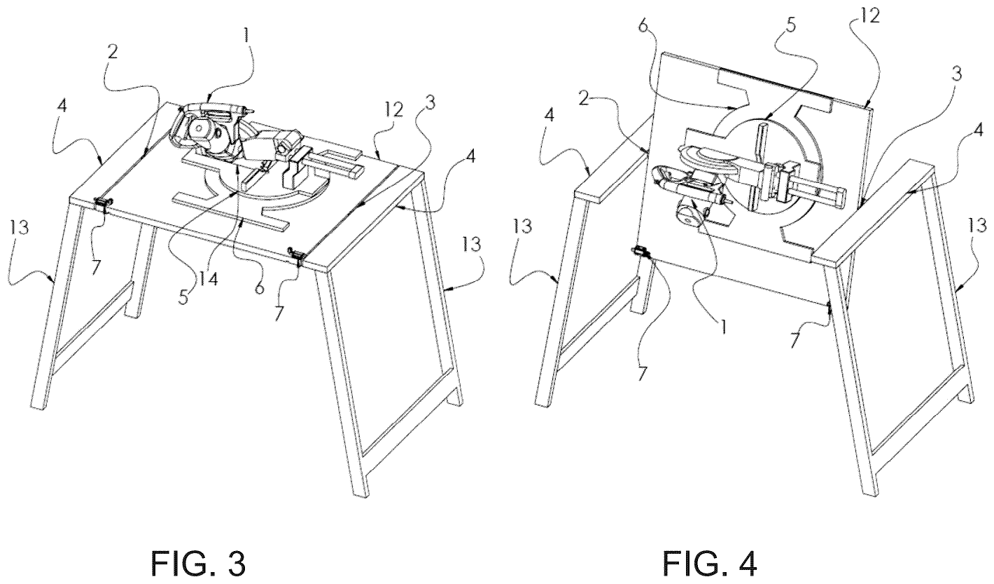

FIG. 3 shows a perspective view of an embodiment of a flip platform for a combination saw motor with a circular blade fully rotated 90 degrees clockwise horizontally. Referring now to FIG. 3, base 5 is fully rotated clockwise 90 degrees from its original position, having both base slot 14 and flip platform slot 10 now aligned together and base 5 is secured in this position.

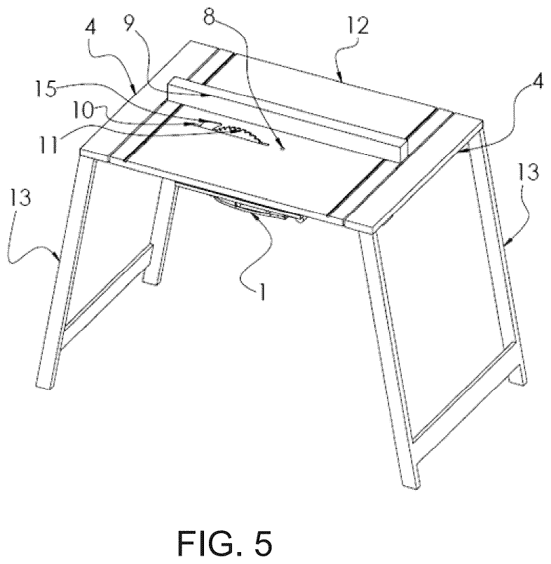

FIG. 4 shows a perspective view of an embodiment of a flip platform for a combination saw motor with a circular blade beginning a 180 degree vertical rotation. Referring now to FIG. 4, latches 7 are released from the two horizontal lateral support members 4 and flip platform 12 begins a vertical rotation about left flip platform rotation point 2 and a right flip platform rotation point 3.

FIG. 5 shows a perspective view of an embodiment of a flip platform for a combination saw motor with a circular blade fully rotated 180 degrees vertically. Referring now to FIG. 5, flip platform 12 is fully rotated 180 degrees and latches 7 (not visible in FIG. 5) are engaged with the two lateral support members 4 to secure flip platform 12 in a horizontal position. Saw blade 11 riving knife 15 have passed through base slot 14 and through flip platform slot 10 which are aligned together. Flip platform slot 10 is parallel to a front and back edge of flip platform 12 and perpendicular to a left and right edge of flip platform 12 and is of a length to fully accommodate the diameter of saw blade 11. Saw blade 11 is locked into the desired height (adjustable from zero to about three inches) above the surface of flip platform 12 via a locking mechanism on combination saw motor with a circular blade 1 as is known in the art. Table saw fence 9 is slidable along the surface of flip platform 12 to position the workpiece for the desired width of the rip-cut.

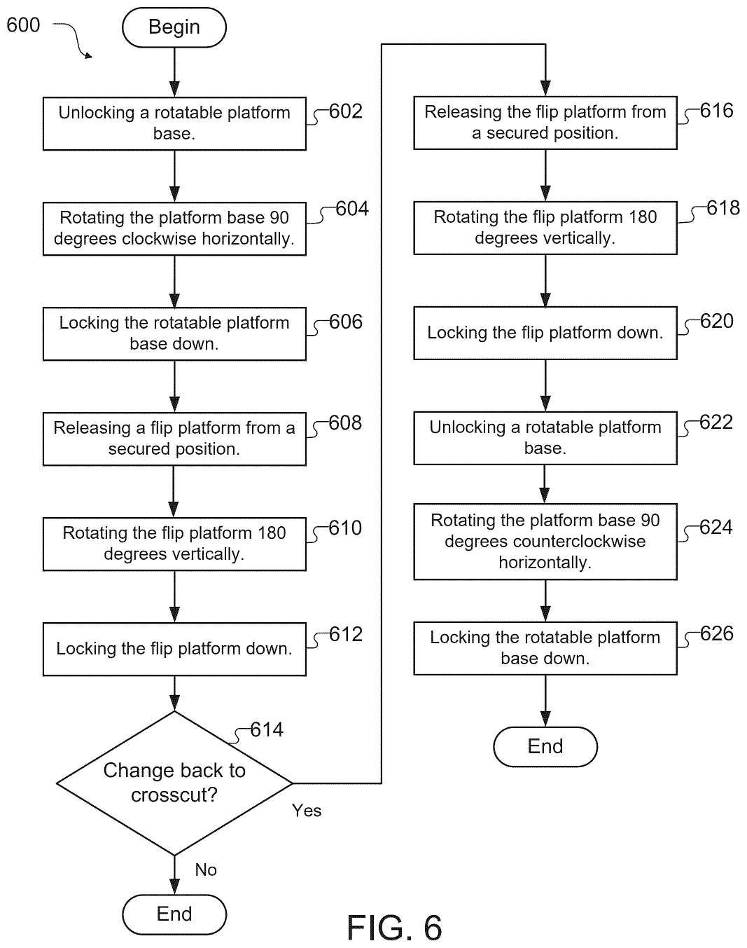

FIG. 6 shows a method for converting a flip platform from a cross cut orientation to a rip-cut orientation for use with a combination saw motor with a circular blade in an embodiment of the invention of a flip platform for a combination saw motor with a circular blade. Referring now to FIG. 6, the method 600 begins in step 602 by unlocking a rotatable platform base 6. Rotating the rotatable platform base 6 by 90 degrees clockwise is performed in step 604 followed by locking the rotatable platform base 6 back down in step 606. Releasing the latches 7 from the two horizontal lateral support members 4 is performed in step 608 thus freeing flip platform 12 from a secured position to be able to rotate. Rotating the flip platform 12 vertically 180 degrees is performed in step 610 followed by locking flip platform 12 down with latches 7 in step 612. Determining step 614 determines if the flip platform 12 needs to be returned to the cross cut position. If no, the method ends. If yes, then control passes to step 616 for releasing the latches 7 from the two horizontal lateral support members 4 thus freeing flip platform 12 from the secured position to be able to rotate. Rotating the flip platform 12 180 degrees vertically is performed in step 618 followed by locking flip platform 12 down with latches 7 in step 620. Unlocking the rotatable platform base 6 is performed in step 622 followed by rotating the rotatable platform base 6 by 90 degrees counterclockwise in step 624. Locking the rotatable platform base 6 back down is performed in step 626 and the method ends. The flip platform 12 can be returned to the rip-cut position by starting method 600 over again in step 602.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. It will be understood by those skilled in the art that many changes in construction and widely differing embodiments and applications will suggest themselves without departing from the scope of the disclosed subject matter.

What is claimed is:

1. A method for converting a flip platform, the method comprising the steps of:
(a) rotating a rotatable platform base on the flip platform by 90 degrees clockwise;
(b) releasing a first latch on the flip platform from a first horizontal lateral support member;
(c) releasing a second latch on the flip platform from a second horizontal lateral support member; and
(d) rotating the flip platform vertically 180 degrees.

2. The method for converting a flip platform according to claim 1 further comprising the step of: unlocking the rotatable platform base before step (a).

3. The method for converting a flip platform according to claim 1 further comprising the step of: locking the rotatable platform base back down after step (a).

4. The method for converting a flip platform according to claim 1 wherein step (d) further comprises the steps of:
locking the first latch on the flip platform to the first horizontal lateral support member; and
locking the second latch on the flip platform to the second horizontal lateral support member.

5. The method for converting a flip platform according to claim 1 further comprising the steps of:
(e) releasing the first latch on the flip platform from the first horizontal lateral support member; and
(f) releasing the second latch on the flip platform from the second horizontal lateral support member.

6. The method for converting a flip platform according to claim 5 further comprising the step of:
(g) rotating the flip platform vertically 180 degrees.

7. The method for converting a flip platform according to claim 6 further comprising the steps of:
(h) locking the first latch on the flip platform to the first horizontal lateral support member; and
(i) locking the second latch on the flip platform to the second horizontal lateral support member.

8. The method for converting a flip platform according to claim 7 further comprising the step of:
(j) unlocking the rotatable platform base.

9. The method for converting a flip platform according to claim 8 further comprising the step of:
(k) rotating the rotatable platform base on the flip platform by 90 degrees counterclockwise.

10. The method for converting a flip platform according to claim 9 further comprising the steps of:
(l) locking the first latch on the flip platform to the first horizontal lateral support member; and
(m) locking the second latch on the flip platform to the second horizontal lateral support member.

11. A flip platform comprising:
a flip platform rotatably supported between a left horizontal lateral support member and a right horizontal lateral support member;
a flip platform slot parallel to a front and back side of the flip platform and perpendicular to a left and right side of the flip platform;
a rotatable platform base rotatably secured to a top side of the flip platform; and
a first latch configured to secure a first side of the flip platform to the left horizontal lateral support member, and a second latch to secure a second side of the flip platform to the right horizontal lateral support member.

12. The flip platform according to claim 11 wherein the first latch and the second latch secure the flip platform in a first horizontal position and thereby configured for cross cuts.

13. The flip platform according to claim 12 wherein the first latch and the second latch secure the flip platform in a second horizontal position that is rotated vertically 180 degrees from the first horizontal position and thereby configured for rip-cuts.

14. The flip platform according to claim 13 wherein the rotatable platform base is configured to receive a base that is securely attached to the rotatable platform base, the base further comprising:
a base slot configured to receive a saw blade when flip platform is in the first horizontal position.

15. The flip platform according to claim 14 wherein the base slot aligns with the flip platform slot to receive the saw blade through both the base slot and the flip platform slot when the flip platform is in the second horizontal position.

16. The flip platform according to claim 11 further comprising:
a first leg that supports the left horizontal lateral support member; and
a second leg that supports the right horizontal lateral support member;
wherein the flip platform is elevated to a convenient working height by the first leg and the second leg.

17. The flip platform according to claim 11 wherein the flip platform further comprises:
a left flip platform rotation point located at a midpoint along the left horizontal lateral support member and at a midpoint along a left side of flip platform; and
a right flip platform rotation point; located at a midpoint along the left horizontal lateral support member and at a midpoint along a right side of flip platform.

18. The flip platform according to claim 11 further comprising:
a center rotation point about which the rotatable platform base rotates with respect to the flip platform.

19. A flip platform comprising:
a flip platform rotatably supported between a left horizontal lateral support member and a right horizontal lateral support member;
a flip platform slot parallel to a front and back side of the flip platform and perpendicular to a left and right side of the flip platform;
a rotatable platform base rotatably secured to a top side of the flip platform;
a first latch configured to secure a first side of the flip platform to the left horizontal lateral support member, and a second latch to secure a second side of the flip platform to the right horizontal lateral support member;
a first leg that supports the left horizontal lateral support member;
a second leg that supports the right horizontal lateral support member, wherein the flip platform is elevated to a convenient working height by the first leg and the second leg;
a left flip platform rotation point located at a midpoint along the left horizontal lateral support member and at a midpoint along a left side of flip platform;
a right flip platform rotation point; located at a midpoint along the left horizontal lateral support member and at a midpoint along a right side of flip platform; and
a center rotation point about which the rotatable platform base rotates with respect to the flip platform.

20. The flip platform according to claim 19 wherein the rotatable platform base is configured to receive a base that is securely attached to the rotatable platform base, the base further comprising:
a base slot configured to receive a saw blade when flip platform is in the first horizontal position configured for cross cuts; and
wherein the first latch and the second latch secure the flip platform in a second horizontal position that is rotated vertically 180 degrees from the first horizontal position and thereby configured for rip-cuts, wherein the base slot aligns with the flip platform slot to receive the saw blade through both the base slot and the flip platform slot when the flip platform is in the second horizontal position.
